(19) United States
(12) Patent Application Publication
(10) Pub. No.: US 2007/0229149 A1
(43) Pub. Date: Oct. 4, 2007

(54) VOLTAGE REGULATOR HAVING HIGH VOLTAGE PROTECTION

(75) Inventors: Feng Pan, Richmond, CA (US); Prashanti Govindu, Santa Clara, CA (US)

Correspondence Address: BEYER WEAVER LLP, P.O. BOX 70250, OAKLAND, CA, 94612-0250, US

(73) Assignee: SanDisk Corporation, Sunnyvale, CA (US)

(21) Appl. No.: 11/278,108

(22) Filed: Mar. 30, 2006

(51) Int. Cl. G05F 1/10

(52) U.S. Cl. 327/543

(57) ABSTRACT

A high voltage device is connected in a voltage divider and couples a regulated voltage to a comparator for voltage regulation. The high voltage device is biased to conduct a current during regulator operation. When regulator operation is terminated, a switch in the voltage divider is opened to terminate current flow in the voltage divider. While the regulated output voltage can be coupled to the high voltage device when the switch is opened, the device node coupled to the comparator remains at a voltage level determined by the device bias voltage and the turn on voltage, V_{T}, of the device, or V bias −V_{T}, when the switch is opened. In one embodiment, the high voltage device comprises a field effect transistor having sufficient width to accommodate the voltage drop across the source and drain.

### CROSS REFERENCE TO RELATED APPLICATIONS

This patent application is related to co-pending application Ser. No. 11/303,387, filed Dec. 16, 2005, entitled CHARGE PUMP REGULATION CONTROL FOR IMPROVED POWER EFFICIENCY, which is incorporated herein by reference for all purposes.

### BACKGROUND OF THE INVENTION

This invention relates to voltage regulators such as used in charge pump circuits for example, and more particularly the invention relates to high voltage protection of a voltage regulator.

FIG. 1 is a schematic diagram of a conventional voltage generation circuit 100. The conventional voltage generation circuit 100 can provide one or more generated voltages to a memory system that provides non-volatile data storage and represents, for example, a memory card (e.g., flash card). The voltage generation circuit 100 includes a charge pump circuit 102. The charge pump circuit 102 operates to boost a lower input voltage (VIN) to produce a higher output voltage (VOUT). The output voltage is coupled to a decoupling capacitor (CD) 104. The output voltage is also coupled to a resistor divider 106. The resistor divider 106 divides the output voltage using resistors R1 and R2. A comparator 108 couples to the resistor divider 106 and to a reference voltage (VREF). The output of the comparator 108 is fed back to the charge pump circuit 102 so that the charge pump circuit 102 can regulate the output voltage so that it remains at a substantially constant voltage level.

Unfortunately, however, the constant regulation of the output voltage for the charge pump circuit 102 and particularly the resistor divider network consumes a substantial amount of power. The power consumed by the constant regulation is particularly problematic when being used with power conscious electronic devices, such as battery-powered electronic devices. Accordingly, there is a need for improved voltage generation circuits that can operate with improved power efficiency.

Copending application Ser. No. 11/303,387 discloses techniques for efficiently generating an output voltage for use within an electronic device, such as a memory system providing data storage. A voltage generation circuit generates the output voltage. The voltage generation circuit includes regulation circuitry that controls regulation of the output voltage to maintain the output voltage at a substantially constant level. According to one aspect of the disclosure, regulation is enabled when needed but disabled when regulation is not necessary, thereby reducing power consumption by the regulation circuitry. The voltage generation circuit is therefore able to operate with improved power efficiency.

A problem can arise when the voltage regulator switch is opened at the end of regulation. Prior to discharge of the regulated high voltage, the voltage can be applied to the regular divider to the sensor amplifier of the comparator. The comparator sense amplifier uses thin oxide devices as well as the on/off switch. Thus the high voltage coupled through the resistor divider can raise the voltage level to the sense amplifier and to the on/off switch above device tolerance and adversely effect device reliability.

One attempt at protecting the sense amplifier from the output voltage is to provide for discharging the output node through the regulation path. Thus, the regulation path facilitates the discharge of the high voltage output node to a voltage level low enough not to damage the thin oxide devices. However, the amount of discharge time is variable due to capacitive loading and discharge strength.

A clamping device can be used to clamp the voltage near the thin film oxide devices after the charge pump is disabled. But provision of clamping devices can complicate the design of the regulator.

The present invention provides a simple modification to the conventional circuit for protecting thin film oxide devices during output voltage discharge while not impacting the normal regulation operation.

### SUMMARY OF THE INVENTION

In accordance with the invention, a high voltage device is connected in a resistor divider and can couple a regulated voltage to a comparator for voltage regulation. The high voltage device is biased to conduct a current during regulator operation. When regulator operation is terminated, a switch in the voltage divider is opened to terminate current flow in the voltage divider. While the regulated output voltage can be coupled to the high voltage device when the switch is opened, the device node coupled to the comparator remains at a voltage level determined by the device bias voltage and the turn on voltage, V_{T}, of the device, or V bias −V_{T}, when the switch is opened.

In one embodiment, the high voltage device comprises a field effect transistor having sufficient width to accommodate the voltage drop across the source and drain.

In one application of the invention, a voltage generation circuit according to an embodiment of the invention includes at least: a charge pump circuit that receives an input voltage and outputs an output voltage at an output terminal, the output voltage being greater than the input voltage, and the charge pump circuit having a control terminal; a switch operatively connected to a ground terminal; a resister divider including the high voltage device operatively connected to the switch and to the output terminal of the charge pump circuit, the resister divider providing a divided voltage, the divided voltage being less than the output voltage from the charge pump circuit; and a comparator operatively connected to the resister divider and to a reference voltage, the comparator comparing the divided voltage to the reference voltage to produce a first control signal that is supplied to the control terminal of the charge pump circuit.

The invention and object and features thereof will be more readily apparent from the following detailed description and appended claims when taken with the drawings.

### BRIEF DESCRIPTION OF THE DRAWINGS

FIG. 1 is a schematic diagram of a conventional voltage generator circuit.

FIG. 2 is a schematic diagram of a voltage generator circuit in accordance with one embodiment of the invention.

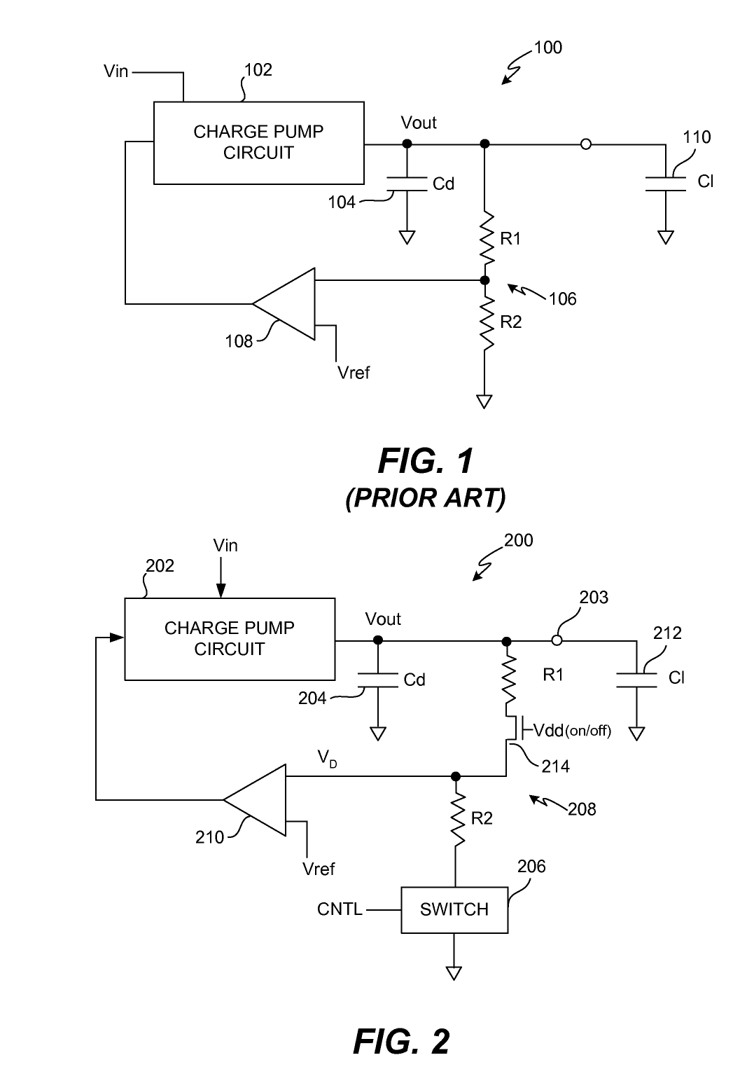

### DETAILED DESCRIPTION OF ILLUSTRATIVE EMBODIMENTS

The invention provides protection for thin oxide devices in a voltage comparator from a regulated high voltage following turn off of the comparator circuit. The invention has many applications, but the invention will be described with reference to voltage generation circuit.

FIG. 2 is a schematic diagram of a voltage generation circuit 200 according to an embodiment of the invention. The voltage generation circuit 200 includes a charge pump circuit 202. The charge pump circuit 202 receives a low input voltage (V_{IN}) which is boosted to output a high output voltage (V_{OUT}) at an output terminal 203. A decoupling capacitor 204 couples the output terminal of the charge pump circuit 202 to ground. A switch 206 connects resistor divider 208 to ground. In one embodiment, the switch 206 can be implemented as a transistor, such as a high-voltage MOSFET. In one example, the switch 206 can be a high voltage PMOS device (with level shifted gate input that can turn on and off based on input). In another example, the switch 206 can be a high voltage NMOS device (with boosted gate voltage when turned on and zero volts when turned off). The resistor divider 208 includes resistors R1 and R2 connected in series. The switch 206 operates under the control of a control signal (CNTL). The resistor divider 208 produces a divided voltage (V_{D}) that is supplied to a first input terminal of a comparator 210. A second input terminal of the comparator 210 receives a reference voltage (V_{REF}). The output of the comparator 210 is a signal, namely, a control signal, that is fed back to the charge pump circuit 202. The control signal is utilized by the charge pump circuit 210 to regulate the output voltage (V_{OUT}) such that it is maintained at the specified voltage level plus or minus some permitted tolerance. In one embodiment, the switch 206, the resister divider 208 and the comparator 210 can be considered regulation circuitry used to regulate the output voltage (V_{OUT}). In another embodiment, the resister divider 208 and the comparator 210 can be considered regulation circuitry used to regulate the output voltage (V_{OUT}). Also, when in use, a load is coupled to the output terminal 203 of the voltage generation circuit 200. The load has a capacitance represented as a load capacitor 212. In other words, the load capacitor 212 represents the capacitance associated with the load that is coupled to the voltage generation circuit 200.

When the switch 206 isolates the resister divider 208 from ground, there is essentially no current flowing through the resister divider 208. Consequently, the voltage generation circuit 200 ceases regulating the output voltage (V_{OUT}), such that the control signal from the comparator 210 is not operational. In this embodiment, the switch 206 gate control can be at supply level to turn on and zero volts to turn off. When turned off, a relatively high voltage can be present at the switch 206. Accordingly, high voltage device 214 is placed in series with resistors R1 and R2 and couples the regulated voltage to node 208 of comparator 10.

The provision of high voltage device 214 in series with the resistor divider network 208 and between the output voltage and the input to comparator 210 allows for normal flow of current through the voltage divider when switch 206 is closed. However, when switch 206 is open, current flow through the resistor divider and through device 210 is extinguished, and the voltage on the node of device 212 coupled to the input of comparator 210 is now limited to the bias voltage V_{DD} less the transistor turn on voltage V_{T}. Any large voltage at out after regulation is terminated, but before the voltage is dissipated will be applied across device 214. Accordingly, device 214 must be a high voltage device such as a field effect transistor in which the device can sustain the high voltage stress. Through normal operation of the regulator and the comparator 210, the resistance of device 214 has very little effect in terms of serial resistance. Since the high voltage device protects the thin oxide devices in the sense amplifier of the comparator and in the on/off switch, there can be no stress of these thin film oxide devices when switch 206 is turned off.

In an alternative embodiment, the bias voltage on high voltage device 214 can be switched on during regulation and switched off (O volt) when the regulator is turned off. Again, when switched off, the voltage at V_{D} cannot exceed 0 volt.

While the invention has been described with reference to specific embodiments, the description is illustrative of the invention and is not to be construed as limiting the invention. For example, the voltage divider can produce a protected voltage for applications other than in a voltage regulator. Thus, various modifications and applications may occur to those skilled in the art without departing from the true spirit and scope of the invention as defined by the appended claims.

What is claimed is:

1. A resistor divider circuit for providing an output voltage comprising:
a) first and second serially coupled resistors,
b) an on/off switch serially coupled between the first and second resistors and a ground terminal, and
c) a high voltage device coupled between the first and second resistors, one node of the high voltage device providing an output voltage when the on/off switch is on, the high voltage device protecting the node from the output voltage when then on/off switch is off.

2. The resistor divider circuit as defined by claim 1 wherein the high voltage device comprises a field effect transistor having sufficient width between source and drain to sustain high voltage stress and withstand the output voltage.

3. The resistor divider circuit as defined by claim 2 wherein the field effect transistor has a gate terminal which is biased (V bias) for conduction with the on/off switch on, the bias voltage less turn on voltage of the field effect transistor (V_{T}) being impressed on the one node of the field effect transistor when the on/off switch is off.

4. The resistor divider circuit of claim 2 wherein the field effect transistor has a gate terminal which receives on and off bias voltage when the on/off switch is on and off, respectively.

5. The resistor divider circuit of claim 1 wherein the output voltage is provided to a comparator in a voltage regulation circuit.

6. A voltage generation circuit comprising:
a charge pump circuit that receives an input voltage and outputs and output voltage at an output terminal, the output voltage being greater than the input voltage, and a charge pump circuit having a control terminal;
a switch operably connected to a ground terminal,
a resistor divider operably connected to the switch and to the output terminal of the charge pump circuit, the resistor divider providing a divided voltage, the divided voltage being less than the output voltage of the charge pump circuit,
a high voltage device coupled in the voltage divider with a node of the high voltage device providing a voltage for comparison when the switch is turned on, the high voltage device protecting the node from the output voltage when the switch is off, and
a comparator operably connected to the node of the high voltage device and to a reference voltage, the comparator comparing the divided voltage to the reference voltage to produce a first control signal that is supplied to the control terminal of the charge pump circuit.

7. The voltage generation circuit as defined by claim 6 wherein the high voltage device comprises a field effect transistor having sufficient source to drain width to withstand the output voltage.

8. The voltage generation circuit as defined by claim 7 wherein the field effect transistor has a gate terminal which is biased (V bias) for conduction during comparator enablement with the switch on, the bias voltage less turn on voltage of the field effect transistor (VT) being impressed on the one node of the field effect transistor when the switch is turned off.

9. The voltage generation circuit of claim 7 wherein the field effect transistor has a gate terminal which receives on and off bias voltage when the on/off switch is on and off, respectively.
